(19) United States
(12) Patent Application Publication
(10) Pub. No.: US 2007/0024958 A1
(43) Pub. Date: Feb. 1, 2007

(54) Lens system for ultra-small camera module and image forming lens with infrared ray filtering function used therefor

(75) Inventors: Yun Seok Choi, Kyungki-do (KR); Ho Seop Jeong, Kyungki-do (KR); Sung Hwa Kim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/495,661

(22) Filed: Jul. 31, 2006

(30) Foreign Application Priority Data
Aug. 1, 2005 (KR) 10-2005-70347

(51) Int. Cl. G02B 13/14

(52) U.S. Cl. 359/356; 359/350

(57) ABSTRACT

The invention relates to a lens system for an ultra-small camera module using an image forming lens having an infrared ray filtering function. The lens system includes an infrared ray filter lens group for filtering infrared rays and forming an image. The infrared ray filter lens group includes a lens substrate having planar opposed surfaces, for filtering the infrared rays incident onto an image sensor, a first lens element formed on an object-side surface of the lens substrate, and a second lens element formed on an image-side surface of the lens substrate. The lens system also includes at least one infrared ray transmissive lens group having at least one lens, disposed in front of or behind the infrared ray filter lens group. The image sensor senses the light transmitted through the infrared ray filter lens group and the infrared ray transmissive lens group.

### CLAIM OF PRIORITY

This application claims the benefit of Korean Patent Application No. 2005-70347 filed on Aug. 1, 2005, in the Korean Intellectual Property Office, the disclosure of which is incorporated herein by reference.

### BACKGROUND OF THE INVENTION

1. Field of the Invention

The present invention relates to a lens system for an ultra-small camera module, and more particularly, to a lens system for an ultra-small camera module that does not additionally have an infrared ray filter.

2. Description of the Related Art

These days, many different types of video cameras, still video cameras or mobile phone cameras adopt image sensors such as CCD or CMOS for their image forming surfaces. A camera module having such an image sensor requires a lens system, which needs to be miniaturized and low-cost.

In a general camera module, electronic components and an image sensor such as a CCD or CMOS are mounted on a substrate, and an infrared ray filter and a lens system are housed in a housing. In the camera module, the light passed through the lens system and the infrared ray filter forms an image on the image sensor such as the CCD or CMOS. Then, the light received by the image sensor is converted by an electric signal to be outputted as a picture via the electronic components.

The image sensor such as the CCD or CMOS is sensitive not only to visible light but also to infrared rays, and thus the received infrared rays may result in degradation of the resolution and quality of the image. Therefore, in order to avoid infrared rays from coming into an image pick-up system, the infrared ray filter is disposed in front of an incident surface of the image pick-up device.

However, the conventional camera module must be equipped with the infrared ray filter in the back of an image forming lens in order to filter the infrared rays. Thus, an additional space for mounting the infrared ray filter is required, hindering miniaturization and compactness of the camera module and reduction of the manufacturing costs.

### SUMMARY OF THE INVENTION

The present invention has been made to solve the foregoing problems of the prior art and therefore an object of certain embodiments of the present invention is to provide a lens system for an ultra-small camera module which does not require an infrared ray filter besides an image forming lens, miniaturizing and reducing the manufacturing costs of the camera module, and an image forming lens having an infrared ray filtering function used in the camera module.

Another object of certain embodiments of the invention is to provide an image forming lens having an infrared ray filtering function, which is easily manufactured to have an infrared ray filtering function.

Further another object of certain embodiments of the invention is to provide an image forming lens with an infrared ray filtering function, which easily corrects aberrations while having improved optical characteristics.

According to an aspect of the invention for realizing the object, there is provided a lens system for an ultra-small camera module, including: an infrared ray filter lens group for filtering infrared rays and forming an image, wherein the infrared ray filter lens group includes a lens substrate having planar opposed surfaces, the lens substrate filtering the infrared rays incident onto an image sensor, a first lens element formed on an object-side surface of the lens substrate, and a second lens element formed on an image-side surface of the lens substrate; at least one infrared ray transmissive lens group disposed in front of or behind the infrared ray filter lens group, the infrared ray transmissive lens group having at least one lens; and the image sensor sensing the light transmitted through the infrared ray filter lens group and the infrared ray transmissive lens group.

Preferably, the lens substrate has a substance for filtering infrared rays coated on at least one surface thereof to filter the infrared rays incident onto the image sensor.

Preferably, the lens substrate absorbs infrared rays to filter infrared rays incident onto the image sensor.

Preferably, each of the first lens element and the second lens element is formed via one selected from a group consisting of replica, hot embossing, UV embossing and molding.

Preferably, at least one of the object-side surface of the first lens element or the image-side surface of the second lens element comprises an anti-reflective coating.

Preferably, at least one of the infrared ray transmissive lens group, the infrared ray filter lens group and the image sensor are disposed in their order from the object side.

According to another aspect of the invention for realizing the object, there is provided an image forming lens including: a lens substrate having planar opposed surfaces, the lens substrate filtering infrared rays incident onto an image sensor; a first lens element formed on an object-side surface of the lens substrate; and a second lens element formed on an image-side surface of the lens substrate.

Preferably, the lens substrate has a substance for filtering infrared rays coated on at least one surface thereof to filter infrared rays incident onto the image sensor.

Preferably, the lens substrate absorbs infrared rays to filter infrared rays incident onto the image sensor.

Preferably, each of the first lens element and the second lens element is formed via one selected from a group consisting of replica, hot embossing, UV embossing and molding.

Preferably, at least one of the object-side surface of the first lens element or the image-side surface of the second element comprises an anti-reflective coating.

According to the present invention, the lens elements are formed on the lens substrate having an infrared ray filtering function to perform both the infrared ray filtering function and the image forming function. In addition, the lens elements are formed on both sides of the lens substrate to more effectively improve the optical characteristics of the lens system such as correcting the aberrations.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a lens arrangement of a lens system for an ultra-small camera module according to Example 1 of the present invention;

FIG. 2 illustrates aberrations of Example 1 illustrated in FIG. 1, in which (a) represents a spherical aberration, (b) represents astigmatism and (c) represents distortion;

FIGS. 3a and 3b are graphs illustrating Modulation Transfer Function (MTF) characteristics of Example 1 shown in FIG. 1;

FIG. 4 illustrates a lens arrangement in a lens system for an ultra-small camera module in Comparative Example 1 in comparison with Example 1;

FIG. 5 illustrates aberrations of Comparative Example 1 shown in FIG. 4, in which (a) represents a spherical aberration, (b) represents astigmatism and (c) represents distortion;

FIGS. 6a and 6b are graphs illustrating MTF characteristics of Comparative Example 1 shown in FIG. 4;

FIG. 7 illustrates a lens arrangement in a lens system for an ultra-small camera module according to Example 2 of the present invention;

FIG. 8 illustrates aberrations of Example 2 shown in FIG. 7, in which (a) represents a spherical aberration, (b) represents astigmatism and (c) represents distortion;

FIGS. 9a and 9b are graphs illustrating MTF characteristics of Example 2 shown in FIG. 7;

FIG. 10 illustrates a lens arrangement in a lens system for an ultra-small camera module of Comparative Example 2 in comparison with Example 2 of the present invention;

FIG. 11 illustrates aberrations of Comparative Example 2 shown in FIG. 10, in which (a) represents a spherical aberration, (b) represents astigmatism and (c) represents distortion;

FIGS. 12a and 12b are graphs illustrating MTF characteristics of Comparative Example 2 shown in FIG. 10; and

FIG. 13 is a schematic view illustrating an image forming lens having an infrared ray filtering function.

### DETAILED DESCRIPTION OF THE PREFERRED EMBODIMENT

Preferred embodiments of the present invention will now be described in detail with reference to the accompanying drawings.

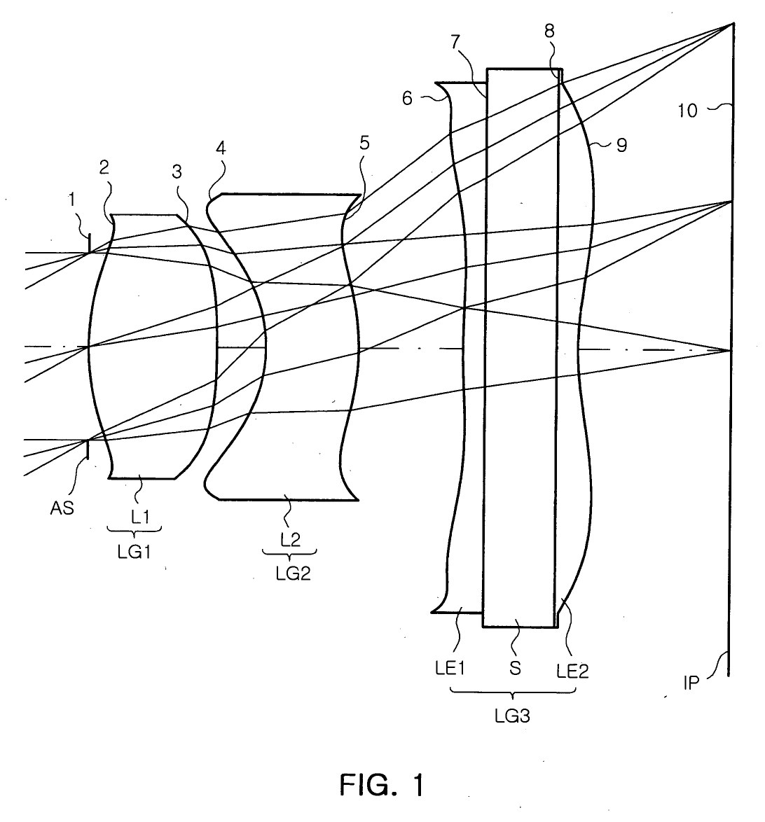

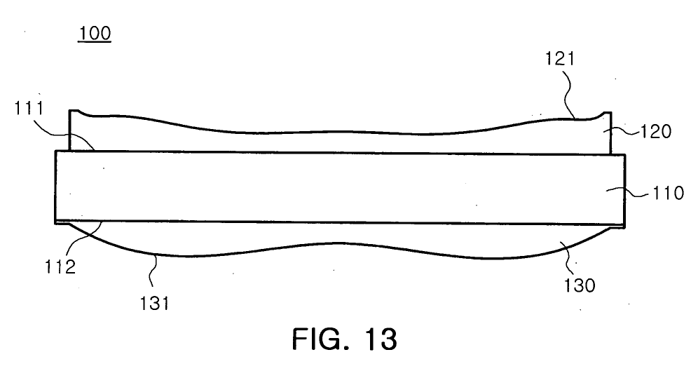

FIG. 1 illustrates a lens arrangement in a lens system for an ultra-small camera module according to Example 1 of the present invention, and FIG. 13 is a schematic view illustrating an image forming lens having an infrared ray filtering function according to the present invention.

As shown in FIG. 1, the ultra-small camera module incorporating the image forming lens having an infrared ray filtering function according to the present invention includes an infrared ray filter lens group LG3, infrared ray transmissive lens groups LG1 and LG2 and an image sensor IP.

The infrared ray filter lens group LG3 (refer to 100, FIG. 13) includes a lens substrate S having planar opposed surfaces 7 and 8, which filters infrared rays incident onto the image sensor IP, a first lens element LE1 formed on an object-side surface 7 of the lens substrate S, and a second lens element LE2 formed on an image-side surface 8 of the lens substrate S.

The infrared ray filter lens group LG3 carries out both the infrared ray filtering function and the image forming function.

Therefore, the lens system for the ultra-small camera module according to the present invention does not require an infrared ray filter besides the image forming lens, thus enabling miniaturization without the space for mounting the infrared ray filter and saving the costs for installation of an infrared ray filter.

In particular, the lens system according to the present invention has the lens elements LE1 and LE2 with refracting surfaces, formed on both sides of the lens substrate S, thereby efficiently correcting aberrations while attaining superior optical characteristics.

Here, the lens substrate S may have a substance for filtering infrared rays coated thereon or may include a substance for absorbing infrared rays therein or only in a surface portion thereof in order to filter infrared rays incident onto the image sensor IP such as the CCD or CMOS.

Such a substance for filtering the infrared rays may be composed of a multi-layer dielectric film for filtering the infrared rays, but is not limited thereto and may adopt other generally-known substance.

In addition, the infrared ray filter lens group LG3 according to the present invention is easily manufactured since a substance for filtering the infrared rays is coated on at least one side of the transparent lens substrate S made of planer glass.

Alternatively, the lens substrate S may include a substance for absorbing the infrared rays therein or only in a surface portion thereof to filter the infrared rays.

The lens substrate S may adopt a generally-known substance to absorb the infrared rays. This substance can be incorporated in a generally-known type of filter such as BS-7 capable of absorbing the infrared rays on its own, which can be used as the lens substrate S.

In the same manner, the lens substrate S may adopt a generally-known type of infrared ray filter such as BK7, D263, B270 and the like. It is also possible to form lens elements LE1 and LE2 on both sides of the filter.

In order to form the first lens element LE1 and the second lens element LE2 on the lens substrate S having the infrared ray filtering function, the generally-known replica method using a polymer can be used.

Using this replica method, a plurality of infrared ray filter lens group LG3 can be formed simultaneously to enable mass production.

In addition, a well-known method selected from a group consisting of hot embossing, UV embossing or molding may be suitably adopted in consideration of the shape of the infrared ray filter lens group LG3 or the material of the lens elements LE1 and LE2.

Preferably, at least one of the object-side surface 6 of the first lens element LE1 and the image-side surface 9 of the second lens element LE2 can comprise an anti-reflective coating to prevent degradation of optical capabilities due to reflection of light, etc.

In the meantime, the infrared ray transmissive lens groups LG1 and LG2 for performing only the image forming function, not the infrared ray filtering function, may be disposed in front of or behind the infrared ray filter lens group LG3.

Each of the infrared ray transmissive lens groups LG1 and LG2 may be composed of at least one lens to perform optical functions required by the entire lens system.

In addition, there may be more than one of the infrared ray transmissive lens groups LG1 and LG2, the number of which may be decreased or increased depending on the optical capabilities required of the lens system.

For example, as shown in FIG. 1, two infrared ray transmissive lens groups LG1 and LG2 may be disposed in front of the infrared ray filter lens group LG3, which however does not limit the present invention.

In addition, in the lens system according to the present invention as shown in FIG. 1, the infrared ray transmissive lens groups LG1 and LG2 may be disposed in the front side and the infrared ray filter lens group LG3 may be disposed in the back side. In this case, power is determined and various aberrations are corrected by the infrared ray transmissive lens group LG1 and LG2, whereas the image surface correction such as decreasing the incident angle of the light incident onto the image sensor IP can be conducted by the infrared ray filter lens group LG3.

It is preferable that the infrared ray filter lens group LG3 is disposed directly in front of the image sensor IP since it has minor effects on the optical characteristics of the entire system, which however does not limit the present invention. Alternatively, the infrared ray filter lens group LG3 may be disposed closest to the object side or between the infrared ray transmissive lens groups.

In the meantime, the image sensor such as the CCD or CMOS for sensing the light transmitted through each of the lens groups LG1, LG2 and LG3 is disposed behind the infrared ray filter lens group LG3 and the infrared ray transmissive lens groups LG1 and LG2.

According to another aspect of the invention, an image forming lens 100 with an infrared ray filtering function is provided, as shown in FIG. 13.

The image forming lens 100 includes a lens substrate 110 having planar opposed surfaces 111 and 112, for filtering the infrared rays incident onto the image sensor, a first lens element 120 formed on an object-side surface 111 of the lens substrate 110, and a second lens element 130 formed on an image-side surface 112 of the lens substrate 110.

Likewise with the aforedescribed infrared ray filter lens group LG3, the image forming lens 100 performs both the infrared ray filtering function and the image forming function.

In particular, the image forming lens 100 according to the present invention includes the lens elements 120 and 130 having refracting surfaces, at both sides thereof, thereby efficiently correcting various aberrations while achieving superior optical characteristics.

Here, the lens substrate 110 may be configured to have a substance for filtering the infrared rays coated on a surface thereof or may include a substance for absorbing the infrared rays therein or only in a surface portion thereof in order to filter the infrared rays incident onto the image sensor IP such as the CCD or CMOS.

As described hereinabove, such a substance for filtering the infrared rays may comprise a multi-layer dielectric film but is not limited thereto, and can use other generally-known substance.

In addition, the image forming lens 100 according to the present invention can be easily manufactured since the substance for filtering the infrared rays is coated on at least one surface of the transparent lens substrate 110 made of planar glass.

Alternatively, the lens substrate 110 may include a substance for absorbing the infrared rays therein or only in a surface portion thereof to filter the infrared rays.

The lens substrate 110 may adopt a generally-known substance for the substance for absorbing the infrared rays. This substance can be incorporated in a generally-known type of filter such as BS-7 capable of absorbing the infrared rays on its own, which can be used as the lens substrate 110.

In the same manner, the lens substrate 110 may adopt a generally-known type of infrared ray filter such as BK7, D263, B270 and the like. It is also possible to form lens elements 120 and 130 on both sides of the filter.

As one of the methods for forming the first lens element 120 and the second lens element 130 on the lens substrate 110 with the infrared ray filtering function, the generally-known replica method using a polymer can be used.

Using this replica method, a plurality of image forming lens 100 can be formed simultaneously, enabling mass production.

In addition, a generally-known method selected from a group consisting of hot embossing, UV embossing or molding may be suitably adopted in consideration of the shape of the image forming lens 100 or the material of the lens elements 120 and 130.

Preferably, at least one of the object-side surface 121 of the first lens element 120 and the image-side surface 131 of the second lens element 130 can comprise an anti-reflective coating, thereby preventing degradation of the optical capabilities due to reflection of light, etc.

Now, operations of the invention will be examined in detail with Examples and Comparative Examples using specific numeric values.

The aspherical surfaces used in each of following Examples and Comparative Examples are obtained by following known Equation 1, in which ‘E and a number following the E’ used in conic constants K and aspherical coefficients A, B, C, D and E represent a 10's power. For example, E+01 and E-02 represent 10¹ and 10⁻², respectively.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + … \qquad Equation 1$$

Z: distance toward an optical axis from a vertex of a lens
Y: distance toward a direction perpendicular to an optical axis
r: radius of curvature on a vertex of a lens
K: conic constant
A, B, C, D and E aspherical coefficients

### EXAMPLE 1

Following Table 1 shows numeric values of the lens system according to Example 1 of the present invention.

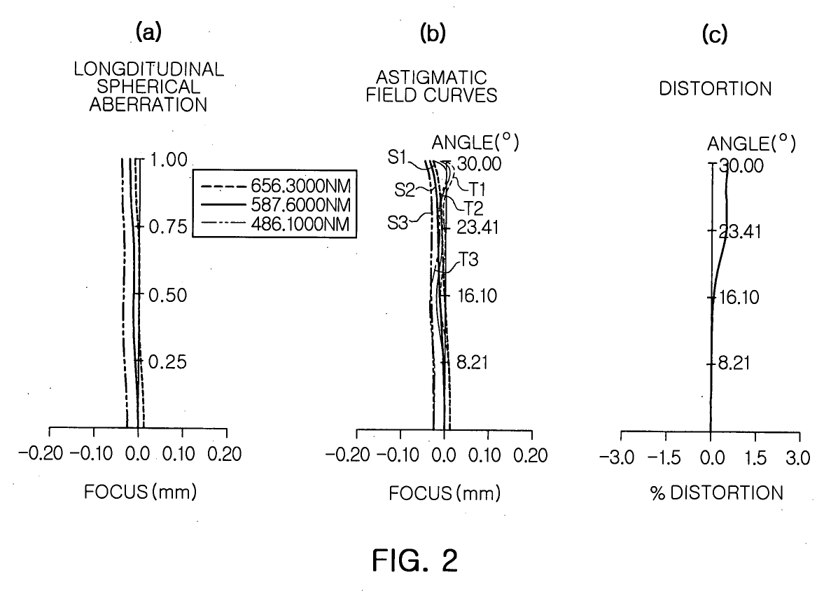

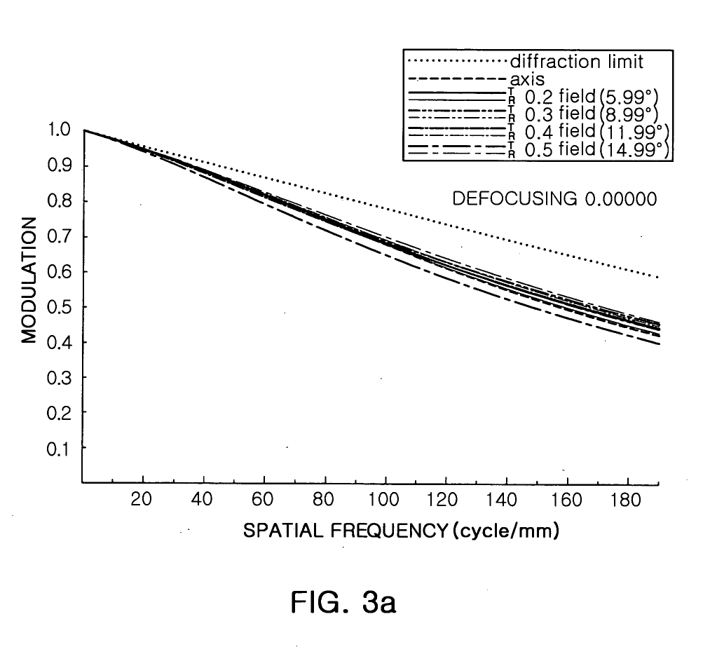

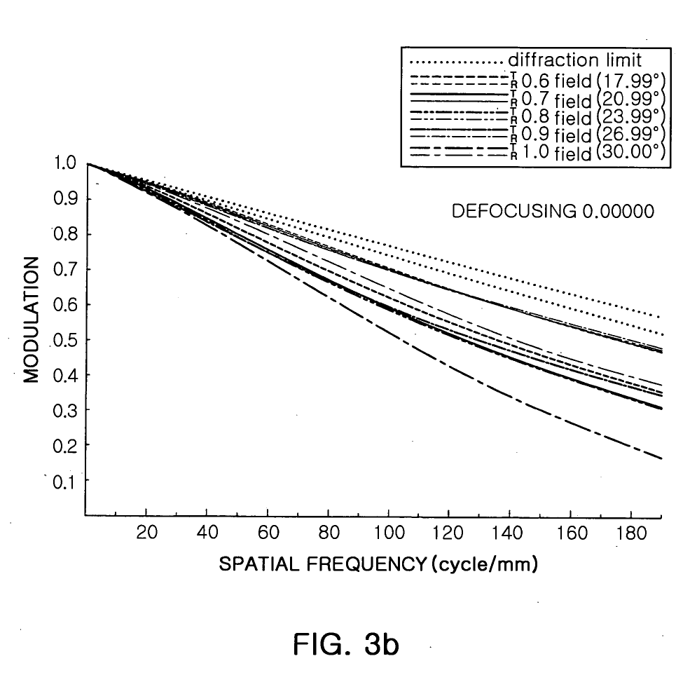

FIG. 1 is a diagram illustrating a lens arrangement of the lens system of the ultra-small camera module according to Example 1 of the present invention, FIGS. 2a to 2c show aberrations of the lens system of the ultra-small camera module shown in Table 1 and FIG. 1, and FIGS. 3a and 3b are graphs showing Modulation Transfer Function (MTF) characteristics of Example 1.

In the graphs illustrating astigmatism, “S” represents sagittal and “T” represents tangential.

In the meantime, the MTF depends on a spatial frequency of a cycle per millimeter and is defined by following Equation 2 between a maximum intensity and a minimum intensity of light.

$$MTF = \frac{Max - Min}{Max + Min} \qquad Equation 2$$

That is, if the MTF is 1, a resolution is most ideal, but degrades with the decrease of the value of the MTF.

As shown in FIG. 1, the lens system according to Example 1 includes, sequentially from an object side, an aperture stop AS, a first infrared ray transmissive lens group LG1 composed of a first lens L1, a second infrared ray transmissive lens group LG2 composed of a second lens L2, an infrared ray filter lens group LG3 for filtering the infrared rays and forming an image, and an image sensor IP disposed behind the infrared ray filter lens group LG3. The infrared ray filter lens group LG3 includes a lens substrate S with a substance for filtering the infrared rays coated on an object-side surface 7 thereof, a first lens element LE1 formed on the object-side surface 7 of the lens substrate S, and a second lens element LE2 formed on an image-side surface 8 of the lens substrate S.

In Example 1, the F number FNo is 3.0, the angle of view is 60 degrees, the distance from the aperture stop AS to the image plane IP (hereinafter, referred to as ‘TL’) is 4.484 mm, and the effective focal length f of the lens system is 4.019 mm.

TABLE 1

| | Radius of | surface | | | |
|---|---|---|---|---|---|
| Surface | Curvature | Interval t | Refractive | Abbe | |
| No. | R (mm) | (mm) | Index n_{d} | Number | Other |
| 1 | ∞ | 0.000 | | | Aperture stop |
| *2 | 1.697 | 0.900 | 1.583 | 59.3 | First lens |
| *3 | −5.574 | 0.343 | | | |
| *4 | −1.065 | 0.650 | 1.607 | 27 | Second lens |
| *5 | −1.775 | 0.736 | | | |
| *6 | 4.974 | 0.150 | 1.590 | 34.3 | First lens |
| | | | | | element |
| 7 | ∞ | 0.500 | 1.474 | 57.4 | IR filter |
| 8 | ∞ | 0.150 | 1.590 | 34.3 | Second lens |
| | | | | | element |
| *9 | 2.143 | 1.055 | | | |
| 10 | ∞ | — | | | Image plane |

In Table 1, the symbol * represents an aspherical surface. In Example 1, surface 2 (the object-side surface of the first lens element), surface 3 (the image-side surface of the first lens), surface 4 (the object-side surface of the second lens), surface 5 (the image-side surface of the second lens), surface 6 (the object-side surface of the first lens element) and surface 9 (the image-side surface of the second lens element) are aspherical surfaces.

The values of the aspherical coefficients of Example 1 according to Equation 1 are as in following Table 2.

TABLE 2

| Surface | | | | | | |
|---|---|---|---|---|---|---|
| No. | K | A | B | C | D | E |
| *2 | −1.6132E−01 | −1.7182E−02 | −8.9244E−02 | 1.5951E−01 | −2.7251E−01 | |
| *3 | 1.3535E+01 | −1.7118E−01 | −5.4342E−02 | −5.2823E−02 | 2.6838E−02 | |
| *4 | −8.8079E−02 | −6.3767E−02 | 1.8842E−01 | 4.5494E−01 | −9.8966E−01 | 6.3960E−01 |
| *5 | −3.3173E+00 | −4.8706E−02 | 2.2102E−01 | 2.2309E−02 | −2.0482E−02 | −7.1305E−03 |
| *6 | −5.0898E+01 | −1.6750E−01 | 1.2213E−01 | −6.1047E−02 | 1.9002E−02 | −2.3685E−03 |
| *9 | −1.2606E+01 | −9.0167E−02 | 3.7505E−02 | −1.2061E−02 | 1.8675E−03 | −9.6805E−05 |

### COMPARATIVE EXAMPLE 1

Following Table 3 shows numeric values of Comparative Example 1 in comparison with Example 1 of the present invention.

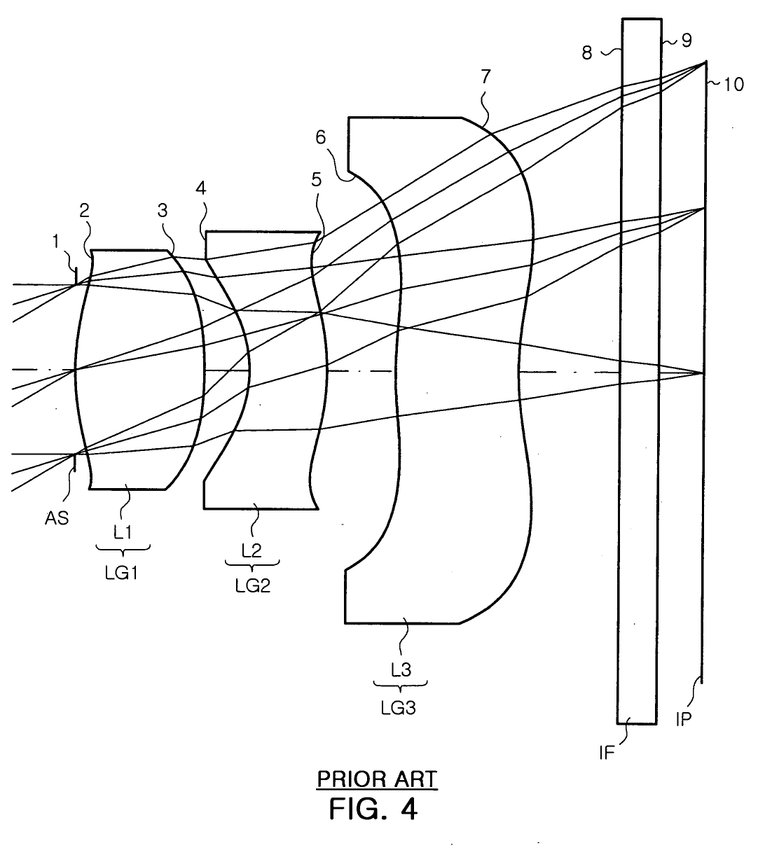

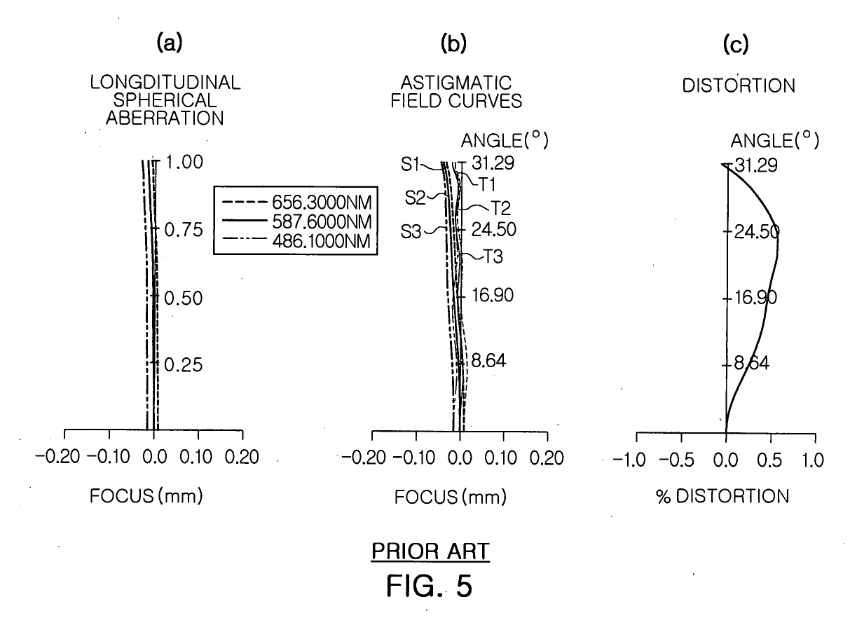

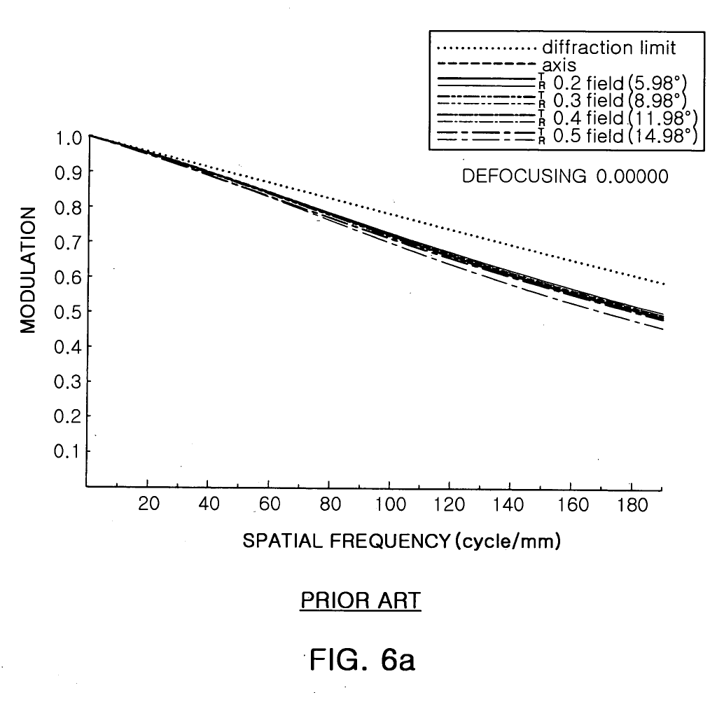

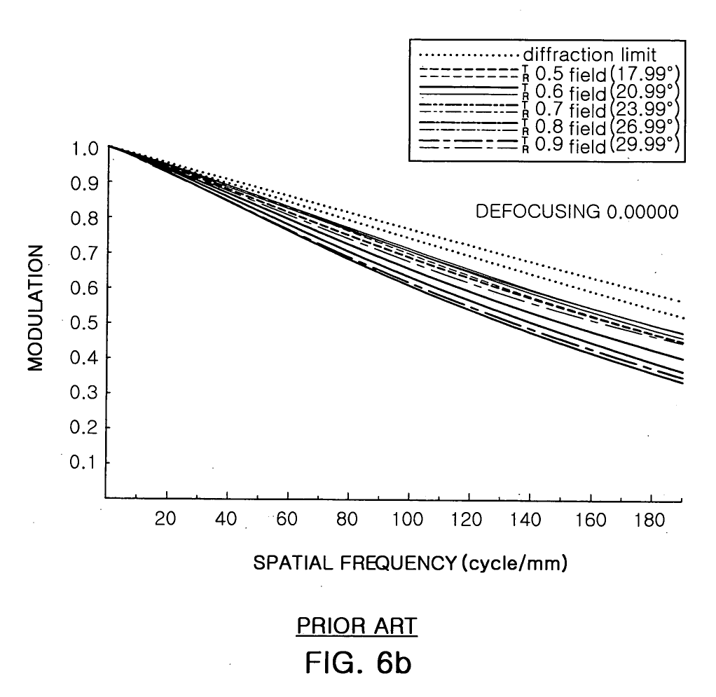

FIG. 4 is a diagram of a lens arrangement of Comparative Example 1 in comparison to Example 1 of the present invention, FIGS. 5a to 5c are graphs showing aberrations of the lens system shown in Table 3 and FIG. 4, and FIGS. 6a and 6b are graphs illustrating MTF characteristics of Comparative Example 1.

As shown in FIG. 4, the lens system according to Comparative Example in comparison with Example 1 includes, sequentially from an object side, an aperture stop AS, a first lens group LG2 composed of a first lens L1, a second lens group LG2 composed of a second lens L2, a third lens group LG3 composed of a third lens L3, an infrared ray filter IF, and an image sensor IP.

To facilitate comparison with Example 1 in which the lens system does not have an infrared rays filter besides an image forming lens, the lens system of Comparative Example 1 was configured to have the substantially same angle of view using the same F number, the same material and similar power with Example 1 while satisfying the aberrations and MTF characteristics required of a general lens system.

In Comparative Example 1, the F number FNo is 3.0, the angle of view is 62.58 degrees, TL is 4.864 mm, and the effective focal length f is 4.030 mm.

TABLE 3

| | Radius of | Surface | | | |
|---|---|---|---|---|---|
| Surface | Curvature R | Interval t | Refractive | Abbe | |
| No. | (mm) | (mm) | Index n_{d} | Number | Other |
| 1 | ∞ | 0.000 | | | Aperture |
| | | | | | Stop |
| *2 | 2.087 | 1.000 | 1.583 | 59.4 | First lens |
| *3 | −3.095 | 0.348 | | | |
| *4 | −1.032 | 0.600 | 1.607 | 27 | Second |
| | | | | | lens |
| *5 | −2.080 | 0.532 | | | |
| *6 | 3.000 | 0.950 | 1.530 | 55.8 | Third lens |
| *7 | 2.268 | 0.784 | | | |
| 8 | ∞ | 0.300 | 1.517 | 64.1 | IR filter |
| 9 | ∞ | 0.350 | | | |
| 10 | ∞ | — | | | Image |
| | | | | | plane |

In Table 3, the symbol represents an aspherical surface. In Comparative example, surface 2 (the object-side surf ace), surf ace 3 (the image-side surf ace of the first lens), surface 4 (the object-side surface of the second lens), surf ace 5 (the image-side surface of the second lens), surface 6 (the object-side surface of the third lens) and surface 7 (the image-side surface of the third lens) are aspherical surfaces.

The values of aspherical coefficients of Comparative Example 1 according to Equation 1 are as in Table 4.

TABLE 4

| Plane | | | | | | |
|---|---|---|---|---|---|---|
| No. | K | A | B | C | D | E |
| *2 | −5.6494E−01 | −2.7088E−02 | −5.3682E−02 | 3.9554E−02 | −1.2117E−01 | |
| *3 | 3.7387E+00 | −1.5540E−01 | −5.9274E−03 | 4.5033E−02 | −4.6123E−02 | |
| *4 | −1.6839E−02 | −3.9594E−02 | 3.6357E−01 | 3.2629E−01 | −7.9736E−01 | 4.8424E−01 |
| *5 | −2.0687E+00 | −9.4144E−02 | 2.8325E−01 | −3.1974E−02 | −5.2314E−02 | 1.6536E−02 |
| *6 | −7.6955E+00 | −2.2365E−01 | 1.4109E−01 | −6.5908E−02 | 1.7518E−02 | −2.5902E−03 |
| *7 | −1.7273E+00 | −1.6016E−01 | 7.1090E−02 | −2.5264E−02 | 5.0576E−03 | −4.7057E−04 |

### EXAMPLE 2

Following Table 5 shows numeric values of a lens system according to Example 2.

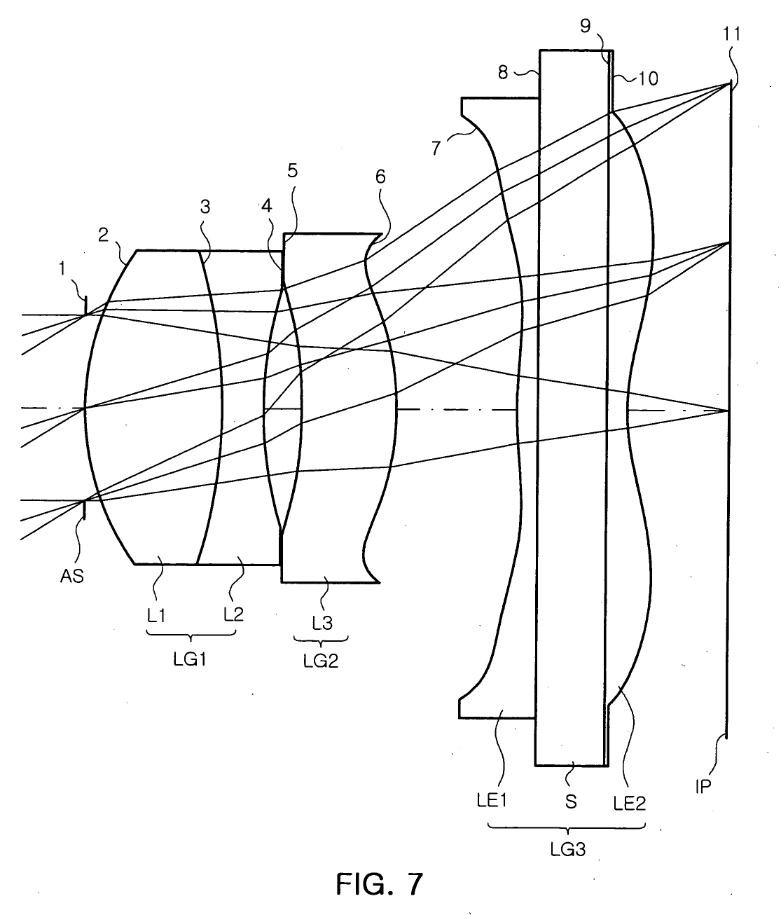

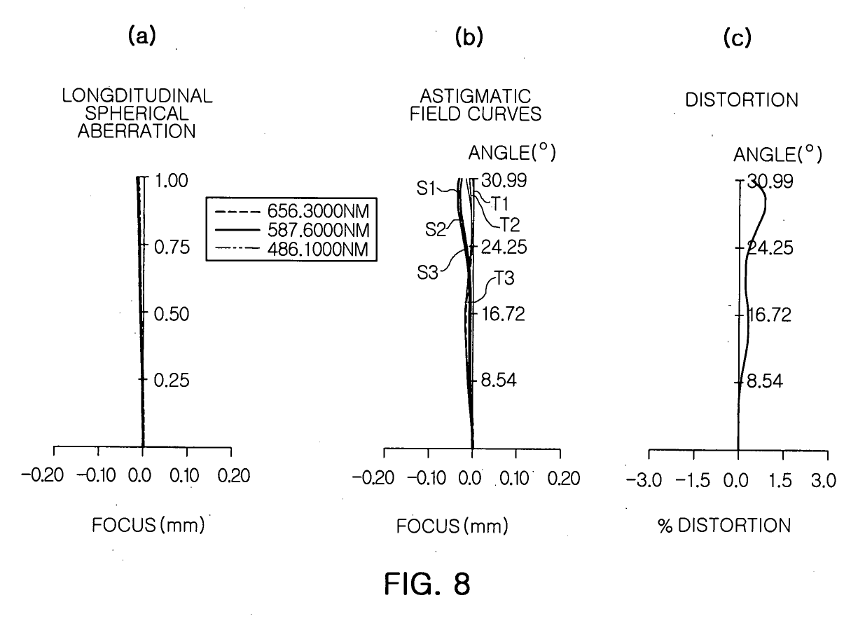

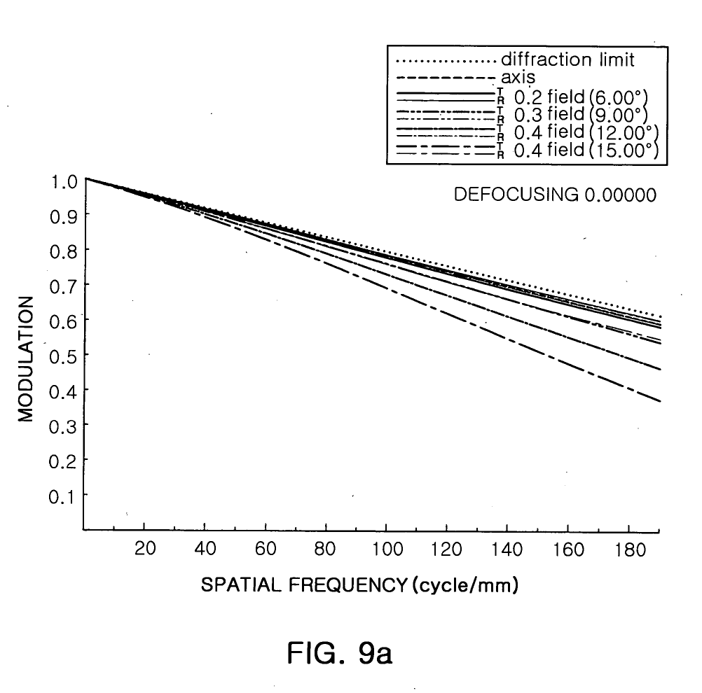

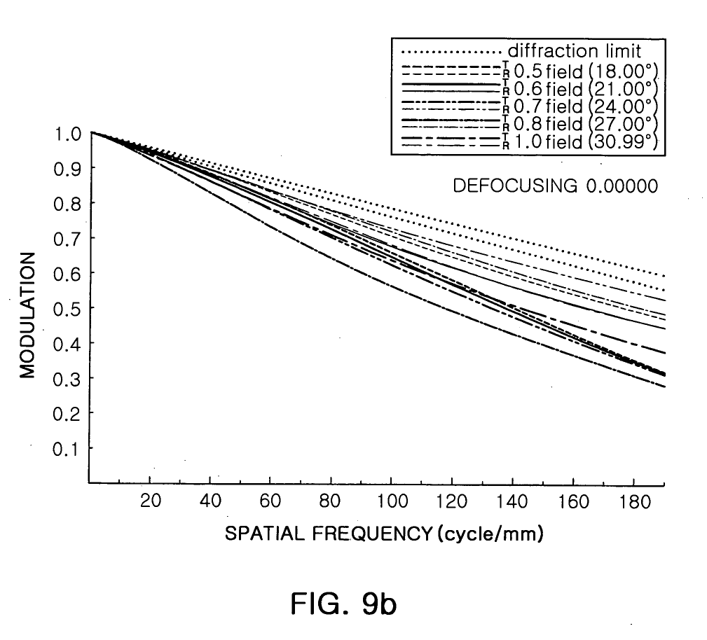

Also, FIG. 7 is diagram illustrating a lens arrangement of the lens system of an ultra-small camera module according to Example 2, FIGS. 8a to 8c are graphs showing aberrations of the lens system of the ultra-small camera module shown in FIGS. 5 and 7, and FIGS. 9a and 9b are graphs illustrating MTF characteristics of Example 2.

As shown in FIG. 7, the lens system according to Example 2 includes, from an object side, an aperture stop AS, a first infrared ray transmissive lens group LG1 composed of a doublet lens of a first lens L1 and a second lens L2, a second infrared ray transmissive lens group LG2 composed of a third lens L3, an infrared ray filter lens group LG3 filtering infrared rays and forming an image, and an image sensor IP disposed behind the infrared ray filter lens group LG3. The infrared ray filter lens group LG3 includes a lens substrate S having a substance for filtering infrared rays coated on an object-side surface 7 thereof, a first lens element LE1 formed on an object-side surface 8 of the lens substrate S, and a second lens element LE2 formed on an image-side surface 9 of the lens substrate S.

In Example 2, the F number FNo is 2.8, the angle of view degrees, TL is 4.686 mm, and the effective focal length 69 mm.

TABLE 5

| | Radius of | Surface | | | |
|---|---|---|---|---|---|
| Surface | Curvature R | Interval t | Refractive | Abbe | |
| No. | (mm) | (mm) | Index n_{d} | Number | Other |
| 1 | ∞ | 0.000 | | | Aperture Stop |
| 2 | 2.041 | 1.000 | 1.804 | 46.5 | First lens |
| 3 | −3.936 | 0.300 | 1.805 | 25.4 | Second lens |
| 4 | 3.116 | 0.275 | | | |
| *5 | −4.544 | 0.689 | 1.530 | 55.8 | Third lens |
| *6 | −2.425 | 0.883 | | | |
| *7 | 3.318 | 0.150 | 1.590 | 34.3 | First lens |
| | | | | | element |
| 8 | ∞ | 0.500 | 1.474 | 57.4 | IR filter |
| 9 | ∞ | 0.150 | 1.590 | 34.3 | Second lens |
| | | | | | element |
| *10 | 1.637 | 0.739 | | | |
| 11 | ∞ | — | | | Image plane |

In Table 5, the symbol * represents an aspherical surface. In Example 2, surface 5 (the object-side surface of the third lens), surface 6 (the image-side surface of the third lens), surface 7 (the object-side surface of the first lens element) and surface 10 (the image-side surface of the second lens element).

The values of aspherical coefficients in Example 2 according to Equation 1 are as in Table 6.

TABLE 6

| Surface | | | | | | |
|---|---|---|---|---|---|---|
| No. | K | A | B | C | D | E |
| *5 | 8.7940E+00 | −7.6976E−02 | −4.2880E−02 | 1.8700E−01 | −1.1271E−01 | 2.6075E−02 |
| *6 | −2.0839E−01 | −9.2110E−02 | 8.7168E−02 | −6.1172E−02 | 7.9822E−02 | −2.1643E−02 |
| *7 | −2.3858E+00 | −1.8786E−01 | 6.0782E−02 | −4.9740E−03 | −6.3206E−04 | 6.2712E−05 |
| *10 | −6.2696E+00 | −7.5420E−02 | 1.6395E−02 | −3.2044E−03 | 6.1747E−04 | −6.1500E−05 |

### COMPARATIVE EXAMPLE 2

Following Table 7 shows numeric values of Comparative Example 2 in comparison with Example 2 of the present invention.

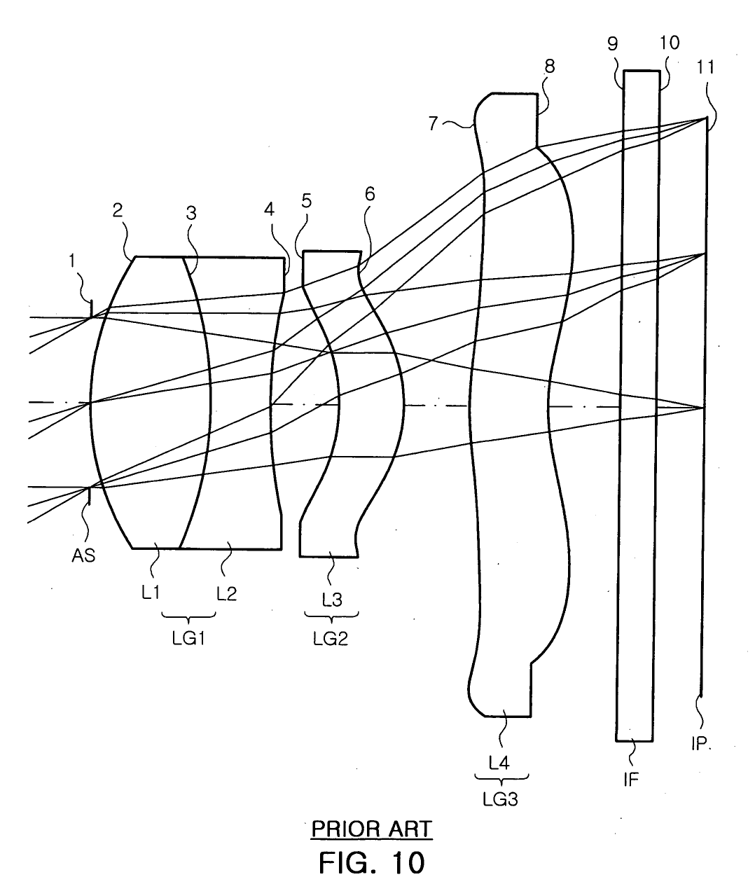

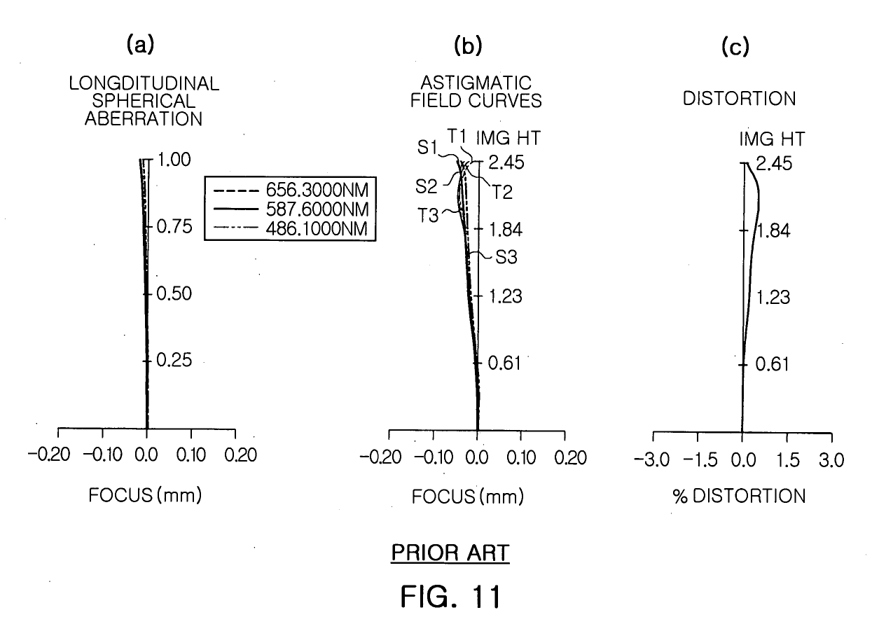

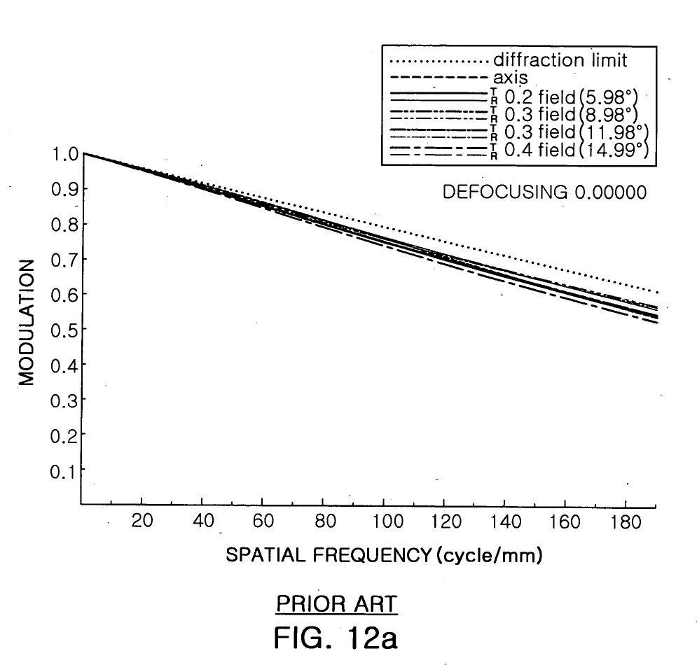

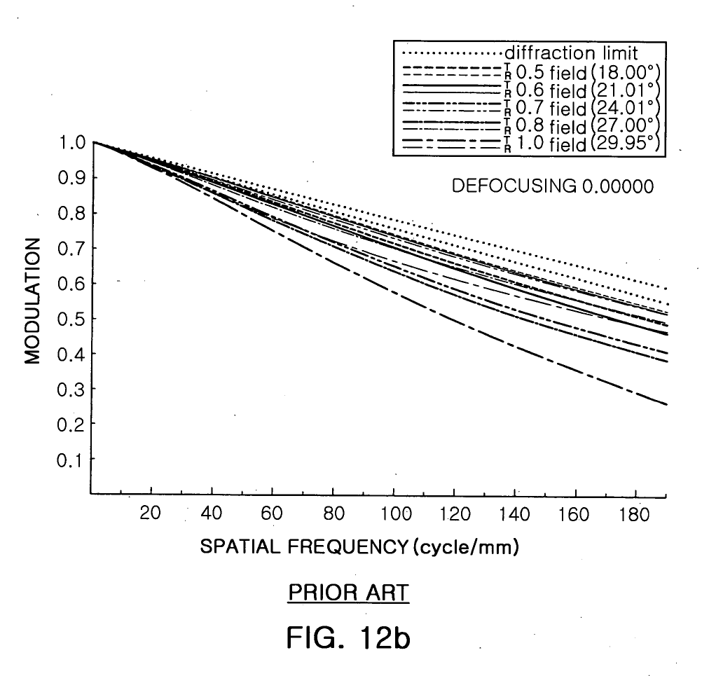

FIG. 10 is a diagram of a lens arrangement of Comparative Example 2 in comparison with Example 2 of the present invention, FIGS. 11a to 11c are graphs showing aberrations of the lens system shown in Table 7 and FIG. 10, and FIGS. 12a and 12b are graphs illustrating MTF characteristics of Comparative Example 2.

As shown in FIG. 10, the lens system of Comparative Example 2 in comparison with Example 2 includes, from an object side, an aperture stop AS, a first lens group LG1 composed of a doublet lens of a first lens L1 and a second lens L2, a second lens group LG2 composed of a third lens L3, a third lens group LG3 composed of a fourth lens L4, an infrared ray filter IF, and an image sensor IP.

To facilitate comparison with Example 2 in which the lens system does not have an infrared ray filter in addition to an image forming lens, Comparative Example 2 is configured to have the substantially same angle of view using the same F number, the same material and similar power with Example 2 while satisfying the aberrations and MTF characteristics required of a general lens system.

In Comparative Example 2, the F number FNo is 2.8, the angle of view is 62.4 degrees, TL is 5.083 mm, and the effective focal length f is 4.028 mm.

TABLE 7

| | Radius of | Surface | | | |
|---|---|---|---|---|---|
| Surface | Curvature R | Interval t | Refractive | Abbe | |
| No. | (mm) | (mm) | Index n_{d} | Number | Other |
| 1 | ∞ | 0.000 | | | Aperture Stop |
| 2 | 2.321 | 1.000 | 1.804 | 46.5 | First lens |
| 3 | −3.244 | 0.500 | 1.805 | 25.4 | Second lens |
| 4 | 4.495 | 0.564 | | | |
| *5 | −1.555 | 0.540 | 1.530 | 55.8 | Third lens |
| *6 | −1.286 | 0.546 | | | |
| *7 | 2.803 | 0.650 | 1.530 | 55.8 | Fourth lens |
| *8 | 1.686 | 0.584 | | | |
| 9 | ∞ | 0.300 | 1.517 | 64.1 | IR filter |
| 10 | ∞ | 0.400 | | | |
| 11 | ∞ | — | | | Image plane |

In Table 7, the symbol * represents an aspherical surface. In Comparative Example 2, surface 5 (the object-side surface of the third lens), surface 6 (the image-side surface of the third lens), surface 7 (the object-side surface of the fourth lens) and surface 8 (the image-side surface of the fourth lens) are aspherical surfaces.

The values of aspherical coefficients of Comparative Example 2 according to Equation 1 are as in Table 8.

TABLE 8

| Plane | | | | | | |
|---|---|---|---|---|---|---|
| No. | K | A | B | C | D | E |
| *5 | −1.2336E+00 | −7.6076E−02 | −5.1969E−02 | 1.9236E−01 | −2.3848E−03 | −5.4833E−02 |
| *6 | −1.5005E+00 | −8.8150E−02 | 7.3114E−02 | −5.2737E−02 | 1.1399E−01 | −4.3882E−02 |
| *7 | −2.6300E+01 | −6.2804E−02 | 3.0030E−02 | −6.1380E−03 | 4.3233E−04 | |
| *8 | −9.2158E+00 | −4.6921E−02 | 7.1705E−03 | −3.2021E−04 | −9.7631E−05 | |

As shown through above Examples and Comparative Examples, Examples according to the present invention exhibit similar optical capabilities with Comparative Examples in terms of various aberrations and MTF characteristics. However, Examples exhibit the significantly decreased values of TL, thus achieving miniaturization of the lens system.

That is, in Example 1, TL decreased about 8% from Comparative Example 1, and in Example 2, TL decreased about 8% from Comparative Example 2, thereby achieving miniaturization of the lens system according to the present invention.

In addition, the lens system according to the present invention does not have an infrared ray filter, thus reducing the manufacturing costs.

Moreover, as confirmed by various aberrations shown above, according to the present invention, the lens elements are formed on both sides of the lens substrate S, thereby attaining superior aberrations and MTF characteristics.

According to the present invention as set forth above, an infrared ray filtering function is added to a lens substrate having a lens element, which thereby performs both the function of filtering the infrared rays and the function of image formation. This allows a lens system that does not require an infrared ray filter besides an image forming lens. Therefore, the present invention allows advantageous effects such as miniaturization of a lens system of a camera module and reduction of manufacturing costs.

In addition, the lens substrate composed of planar surfaces is configured to include a substance for filtering infrared rays coated thereon or include a substance therein for absorbing the infrared rays, thereby allowing easy manufacturing processes.

Further, the lens elements are formed on both sides of the lens substrate to obtain a lens system for a camera module that is easily corrected in its aberrations and is improved in optical characteristics.

While the present invention has been shown and described in connection with the preferred embodiments, it will be apparent to those skilled in the art that modifications and variations can be made without departing from the spirit and scope of the invention as defined by the appended claims.

What is claimed is:

1. A lens system for an ultra-small camera module, comprising:
an infrared ray filter lens group for filtering infrared rays and forming an image, wherein the infrared ray filter lens group includes a lens substrate having planar opposed surfaces, the lens substrate filtering the infrared rays incident onto an image sensor, a first lens element formed on an object-side surface of the lens substrate, and a second lens element formed on an image-side surface of the lens substrate;
at least one-infrared ray transmissive lens group disposed in front of or behind the infrared ray filter lens group, the infrared ray transmissive lens group having at least one lens; and
the image sensor sensing the light transmitted through the infrared ray filter lens group and the infrared ray transmissive lens group.

2. The lens system for an ultra-small camera module according to claim 1, wherein the lens substrate has a substance for filtering infrared rays coated on at least one surface thereof to filter the infrared rays incident onto the image sensor.

3. The lens system for an ultra-small camera module according to claim 1, wherein the lens substrate absorbs infrared rays to filter infrared rays incident onto the image sensor.

4. The lens system for an ultra-small camera module according to claim 1, wherein each of the first lens element and the second lens element is formed via one selected from a group consisting of replica, hot embossing, UV embossing and molding.

5. The lens system for an ultra-small camera module according to claim 1, wherein at least one of the object-side surface of the first lens element or the image-side surface of the second lens element comprises an anti-reflective coating.

6. The lens system for an ultra-small camera module according to claim 1, wherein at least one of the infrared ray transmissive lens group, the infrared ray filter lens group and the image sensor are disposed in their order from the object side.

7. An image forming lens comprising:
a lens substrate having planar opposed surfaces, the lens substrate filtering infrared rays incident onto an image sensor;
a first lens element formed on an object-side surface of the lens substrate; and
a second lens element formed on an image-side surface of the lens substrate.

8. The image forming lens according to claim 7, wherein the lens substrate has a substance for filtering infrared rays coated on at least one surface thereof to filter infrared rays incident onto the image sensor.

9. The image forming lens according to claim 7, wherein the lens substrate absorbs infrared rays to filter infrared rays incident onto the image sensor.

10. The image forming lens according to claim 7, wherein each of the first lens element and the second lens element is formed via one selected from a group consisting of replica, hot embossing, UV embossing and molding.

11. The image forming lens according to claim 7, wherein at least one of the object-side surface of the first lens element or the image-side surface of the second element comprises an anti-reflective coating.
